(19) United States
(12) Patent Application Publication
(10) Pub. No.: US 2026/0131552 A1
(43) Pub. Date: May 14, 2026

(54) ROTARY PRESS AND USE OF A ROTARY PRESS

(71) Applicant: Fette Compacting GmbH, Schwarzenbek (DE)

(72) Inventors: Thomas Pannewitz, Klein Pampau (DE); Michael Markl, Gresse (DE)

(73) Assignee: Fette Compacting GmbH, Schwarzenbek (DE)

(21) Appl. No.: 19/386,882

(22) Filed: Nov. 12, 2025

(30) Foreign Application Priority Data
Nov. 13, 2024 (DE) 10 2024 133 206.9

(51) Int. Cl. B30B 15/30; B30B 11/08; B30B 15/32

(52) U.S. Cl. CPC B30B 15/302; B30B 11/08; B30B 15/32

(57) ABSTRACT

A rotary press includes upper and lower press punches, a die plate defining a plurality of cavities, a filling apparatus that dispenses powder material into the plurality cavities, and a pressing apparatus that presses the powder material in the plurality of cavities into pellets. A scraping apparatus scrapes pellets ejected from the die plate into a first pellet discharge and a sorting apparatus sorts the pellets into a second pellet discharge. The sorting apparatus includes a sorting drive including an electric motor with a magnet driven by a stator and a transmission element, and a sorting element driven by the sorting drive between a sorting position and a rest position. In the sorting position, the sorting element guides pellets into the second pellet discharge. The magnet translates a drive movement, via the transmission element, into a drive movement of the sorting element with a higher drive speed.

### CROSS-REFERENCE TO RELATED APPLICATION

This application claims priority to, and the benefit of, German Patent Application No. 10 2024 133 206.9, filed on Nov. 13, 2024. The entire contents of said application is hereby incorporated by reference.

### TECHNOLOGICAL FIELD

This disclosure is directed to aspects of a rotary press comprising a rotor that can be rotated by means of a rotary drive and includes an upper punch guide for upper press punches and a lower punch guide for lower press punches as well as a die plate arranged between the punch guides. The press punches interact with cavities in the die plate. The rotary press further includes a filling apparatus, by means of which powder material to be pressed is filled into the cavities of the die plate. The rotary press may further include a pressing apparatus with an upper pressing unit and a lower pressing unit, which, during operation, interact with the upper press punches and with the lower press punches to press the powder material in the cavities of the die plate into pellets. In some embodiments, the rotary press includes a scraping apparatus for scraping pellets ejected onto the upper side of the die plate by the lower press punches after pressing into a first pellet discharge. In some embodiments, the rotary press further includes a sorting apparatus for individually sorting pellets into a second pellet discharge. Aspects of the following disclosure are also directed methods of using such a rotary press.

### BACKGROUND

In rotary presses, a plurality of upper and lower press punches are regularly provided, each of which is assigned in pairs to a cavity of a die plate. During operation of the rotary press, the upper and lower press punches rotate together with the die plate, wherein their axial movement is controlled by control cams and is guided by upper and lower punch guides. In the course of rotation, the die plate passes through various apparatuses of the rotary press, namely a filling apparatus, in which powder material to be pressed is guided into the cavities of the die plate, and a pressing apparatus, in which the upper and lower press punches are generally pressed into the cavities by upper and lower pressing rollers to press the powder material into pellets, such as tablets. Downstream of the pressing apparatus, the upper press punches are guided upwards out of the cavities and the pellets generated in the cavities are pushed onto the upper side of the die plate by the lower press punches. Such rotary presses also comprise a scraping apparatus for scraping off the pressed pieces ejected onto the upper side of the die plate by the lower press punches after the pressing process. The scraping apparatus can comprise a scraping channel which is arranged at least in portions above the die plate and guides the pellets ejected onto the upper side of the die plate from the die plate, which rotates under the scraping channel, to a first pellet discharge. The first pellet discharge can, for example, be a discharge for pellets that are recognized as good.

A second pellet discharge is provided, for example for pellets recognized as bad by a sensor system or for sampling of pellets. To sort out pellets from the stream of pellets flowing in the direction of the first pellet discharge, a sorting apparatus, which sorts out pellets into the second pellet discharge depending, for example, on measurement data from sensors provided in the rotary press, is provided. For example, appropriate sensors can be used to monitor the pressing force during the production of the pellets. Depending on the measurement data from a corresponding pressing force sensor, faulty pellets can be detected and sorted out.

In the history of rotary presses, attempts were initially made to sort out pellets using mechanical sorting apparatuses. For this purpose, a deflector element was moved in a mechanically driven manner into a conveying path of the pellets. However, such mechanical sorting apparatuses have proven to be too slow, such that individual sorting of pellets is not reliably possible, especially at the usually rotational high speeds of the die plates of rotary presses. In addition, such systems regularly had too short a stroke, meaning, for example, that tablets with a greater tablet height could not be sorted with the system.

Pneumatic sorting apparatuses, in which the pellets to be sorted out are deflected into the second pellet discharge by a jet of compressed air, are therefore commonly used in rotary presses. The jet of compressed air is generated by a sorting nozzle that can be connected to a compressed air source, wherein a controllable valve is arranged in the line to the nozzle. Such sorting apparatuses are known, for example, from DE 10 2005 005 012 B4 and DE 10 2016 101 028 B4. DE 10 2013 202 975 A1 also describes a sorting apparatus in which sorting out takes place, for example, by means of an air blast. Alternatively, sorting out via a slider is mentioned. Compressed air-driven sorting apparatuses have proven themselves in principle and have become established in practice in the case of rotary presses.

Nevertheless, compressed air-driven sorting apparatuses can also cause problems in some applications. The jet of compressed air can cause powder product or rather product dust located in the pressing chamber of the rotary press to be blown around. This can lead to contamination of surrounding areas of the pressing chamber. In many applications, pharmaceutical air is also required for the jet of compressed air. In addition, such sorting apparatuses are also too slow to reliably sort out individual pellets at very high rotor speeds. In addition, due to the design, in particular due to the pneumatic control, a reliable assignment of the jet of compressed air to a pellet to be sorted out is not always guaranteed.

Starting from the state of the art described above, the invention is therefore based on the object of providing a rotary press and a use of the type mentioned at the beginning, with which it is possible to safely and precisely sort out individual pellets in a simple manner and without risk of contamination of the pressing chamber of the rotary press, even at very high rotational speeds of the rotor of the rotary press.

### SUMMARY

Aspects of the present disclosure are directed to embodiments of a rotary press including a sorting apparatus that comprises a sorting drive and a sorting element which can be moved by the sorting drive between a sorting position and a rest position. In the sorting position, the sorting element is located in a conveying path of the pellets to the first pellet discharge and guides pellets from the conveying path into the second pellet discharge, and in that the sorting drive comprises an electric motor with a magnet driven by a stator of the electric motor. The magnet translates its drive movement, via a transmission element of the sorting drive, into a drive movement of the sorting element with a higher drive speed.

The basic structure of the rotary press, as is the subject matter of the present invention, was explained at the beginning. As explained, the upper and lower punch guides guide the press punches during their axial movement. The punch heads interact with control cams that move the press punches in the axial direction, in particular towards and away from each other, as they rotate with the rotor. The control cams are usually made up of several control cam elements. They can accommodate the punch heads in corresponding guide holders or only rest against a mirror surface of the punch heads. The pressing apparatus usually comprises an upper pressing roller and a lower pressing roller, which interact with the punch heads of the upper and lower press punches, respectively. Several pressing apparatuses of this type can also be provided, for example pre-pressing apparatuses and main pressing apparatuses. The ejector cam as part of the control cams moves the lower press punches upwards after the pellets have been generated in the respective cavities, so that the pellets reach the upper side of the die plate, from where they are conveyed to the first pellet discharge via, for example, a scraping channel. The pellets may, in particular, be tablets. The rotary press may therefore be a rotary tablet press. The tablets can be pharmaceutical tablets, for example.

The scraping apparatus can comprise a scraping channel arranged at least in portions above the die plate, so that pellets broken out of the cavities by the lower press punches onto the upper side of the die plate are guided along the scraping channel from the die plate to the first pellet discharge. However, the scraping apparatus can also comprise, for example, only a scraping element, for example shaped like a sickle, in particular a scraping plate, which guides the pellets broken out onto the upper side of the die plate to the first pellet discharge. A first portion of a scraper or scraping channel can be arranged above the die plate and a second portion can be arranged radially outside the die plate. It is fixed in relation to the rotor, in particular the die plate, so that the die plate rotates under a scraping channel, for example, during operation of the rotary press. The scraper or scraping channel can be arranged at a small distance above the die plate. In particular, the distance is smaller than the thinnest pellet to be produced in the rotary press, so that all pellets are captured. As the die plate rotates, the pellets ejected onto the upper side of the die plate by the lower press punches after the pressing process are scraped off the die plate by a scraper or scraping channel, in particular a channel wall, and conveyed in the direction of the first pellet discharge. As explained, the first pellet discharge can be, for example, a good discharge for pellets recognized as good, for example, by sensors of the rotary press. Correspondingly, the second pellet discharge can be a bad discharge for pellets recognized as bad. However, it can also be, for example, a discharge for sampling.

The present invention proposes an electromechanical sorting apparatus as a departure from the pneumatic sorting apparatuses currently provided in rotary presses. For this purpose, the sorting apparatus has a sorting drive and a mechanical sorting element that can be moved between a sorting position and a rest position by the sorting drive. The sorting element can be a guide element or else scraping element that guides the pellets in the sorting position out of the conveying path and into the second pellet discharge or else scrapes them off the die plate. In the sorting position, the sorting element is located in the conveying path of the pellets to the first pellet discharge, so that it guides pellets from the conveying path into the second pellet discharge. The die plate rotates under the sorting element. In the sorting position, the sorting element can be arranged at a small distance above the die plate. In particular, the distance is smaller than the thinnest pellet to be produced in the rotary press, so that all pellets are captured. As the die plate rotates, the pellets to be sorted out are then scraped from the die plate by the sorting element and conveyed in the direction of the second pellet discharge. In the rest position, however, the sorting element is moved out of the conveying path so that pellets are guided into the first pellet discharge without coming into contact with the sorting element. The sorting element can have a straight shape or a curved shape. It can be arranged at an angle to the direction of rotation of the rotor in the sorting position. This angle can be 90° or, for example, greater than 90°, for example in a range between 90° and 150°.

The sorting drive includes an electric motor with a magnet moved by a stator of the electric motor. The magnet moved by the stator of the electric motor can be a permanent magnet or an electromagnet. The drive movement of the magnet is translated via a transmission element into a drive movement of the sorting element with a higher drive speed than the drive speed of the magnet. Accordingly, the sorting element can be moved back and forth between the sorting position and the rest position at a higher speed than the moving magnet of the electric motor. Thanks to this highly dynamic sorting drive, a mechanical sorting element allows individual pellets to be reliably sorted out to the second pellet discharge even at very high rotational speeds of the rotor of the rotary press.

In some embodiments, pellets are individually sorted out reliably even at very high rotor speeds. Mechanical sorting, and therefore the absence of compressed air, prevents surrounding product powder or dust from being blown around. Unlike with conventional pneumatic sorting systems, no expensive pharmaceutical air needs to be provided for the sorting process. Due to the high sorting speed and the configuration of the rotor, it is possible to reliably assign a specific pellet to a specific pair of punches in a specific cavity, even at high rotor rotational speeds. With the sorting apparatus according to the invention, it is also possible, for example, to sort out several tablets specifically for sampling or to also sort out pellets generated at the beginning or else at the end of a production process. This makes it possible to shift the sorting of tablets, for example for sampling or of bad tablets, which was previously carried out in downstream pellet discharges, for example by means of diverters, to the level of the die plate, thus simplifying the design of the rotary press. If necessary, diverters can be omitted, for example in the first pellet discharge. The sorting apparatus according to the invention also enables a sufficiently large stroke between the sorting position and the rest position, for example by using a lever transmission described in more detail below, so that reliable sorting is possible regardless of the format of the pellets produced, for example a pellet height.

According to one embodiment, the sorting element can comprise a sorting lever that can be pivoted between the sorting position and the rest position. A pivot axis of the pivotable sorting lever can run parallel or perpendicular to the axis of rotation of the die plate. The sorting lever can be configured, for example, as a sorting plate. It allows a large stroke between the sorting position and the rest position for format-independent sorting and forms a particularly practical embodiment for fast sorting.

According to a further embodiment, the sorting element can comprise a sorting wheel which has at least one sorting blade and can rotate between the sorting position and the rest position. An axis of rotation of the rotatable sorting wheel can run parallel or perpendicular to the axis of rotation of the die plate. The sorting wheel can comprise one or more sorting blades, which can be arranged, for example, regularly around the circumference of the sorting wheel. The at least one sorting blade can run in a radial direction. However, curved embodiments of the sorting blade are also conceivable. A sorting wheel of this type can also be used to reliably and quickly sort out pellets.

According to a further embodiment, the magnet can move the transmission element in a translatory manner, wherein the translatory movement of the transmission element is transferred to the sorting element to move it between the sorting position and the rest position. The sorting drive can be linear drive. The magnet is then moved in a translatory manner by the magnetic field of the stator, for example a coil. This translatory movement can be translated to the movement of the sorting element.

According to a further embodiment in this respect, the transmission element can have a transmission pin with a rack portion, wherein the toothed rack portion engages with a gearwheel connected to the sorting element in order to transmit a translatory movement of the transmission pin into a pivoting movement or a rotary movement of the sorting element. The toothed rack portion can be formed in one piece with the transmission pin or be detachably connected to it, for example. In this embodiment, a translatory movement of the transmission pin, and in particular of the magnet of the electric motor, is translated into a rotational movement of the sorting element, so that the sorting element performs a rotational movement with lever transmission.

According to a further embodiment, it may be provided that the transmission element has a transmission projection engaging in an elongated hole in the sorting lever, wherein the magnet drives the transmission projection in a translatory manner to pivot the sorting lever between the sorting position and the rest position in a direction running at an angle to the longitudinal axis of the elongated hole. In this embodiment, the sorting lever has one end arranged on or directly above the die plate in the sorting position and one end lying opposite. This opposite end has the elongated hole and forms a pivot point for the sorting lever. A transmission projection, for example a transmission pin, engages in the elongated hole and is moved in a translatory manner by the moving magnet of the electric motor in a direction that is oblique to the longitudinal axis of the elongated hole. If the electric motor is a linear drive, the axis of movement of the magnet moved in a translatory manner can run parallel to the axis of rotation of the die plate. The translatory movement of the transmission projection causes the sorting lever with lever transmission to move in a rotational manner between the rest position and the sorting position.

In principle, the sorting drive can have a transmission ratio, for example a lever ratio, of more than 2:1, for example 2.5:1, or even more than 3:1. A small movement of the magnet of the electric motor then results in a correspondingly large movement of the sorting element.

As explained, the electric motor can be a linear drive. Of course, the electric motor could also be a rotary drive. The magnet is then moved in a rotational manner by the magnetic field of the stator. This rotational movement can then be transferred directly into a rotational movement of the sorting element via a transmission gear, for example. It is also conceivable to convert the rotational movement of the magnetic field into a translatory movement.

According to a further embodiment, the magnet can be the same distance from the stator during its entire rotational or translatory movement. The magnet can be mounted so as to be movable rotationally or in a translatory manner relative to the stator by means of a plain bearing and a spring element. In this embodiment, the magnet has a highly dynamic but linear force curve over its entire movement path for displacing the sorting element between the sorting position and the rest position. As a result, particularly reliable and precise sorting of the pellets is achieved. This force curve is made possible in that, due to a plain bearing and, for example, a spring coil as a spring element, there is always the same distance between the moving magnet and the stator of the electric motor over the entire travel distance. For example, a coil of a moving electromagnet can be constructed in such a way that a centering spring is arranged at one end and a plain bearing is arranged at the other end. The centering spring is arranged on a side facing away from the sorting element. Such an arrangement reduces the dynamics of the system somewhat, but improves the mechanical load capacity. Nevertheless, high dynamics can be achieved by briefly overcurrenting an electromagnet of the electric motor, for example in the millisecond range. For even faster acceleration of the magnet, instead of an iron armature, a lighter armature material can also be used in the electric motor. If one coil of the electric motor is configured as an induction coil, debouncing can be achieved in this way. The sorting element then bounces less or at best not at all from the die plate when it is moved into the sorting position.

According to a further embodiment, it may be provided that the rotary press comprises a control apparatus and a position sensor, wherein the position sensor detects the rotational position of each cavity of the die plate, wherein the position values detected by the position sensor are applied to the control apparatus, wherein the control apparatus is configured to actuate the sorting drive to move the sorting element between the sorting position and the rest position depending on the position values detected by the position sensor. Furthermore, it can be provided that the sorting apparatus comprises a sorting element sensor for detecting the sorting position and/or the rest position of the sorting element, wherein the position values detected by the sorting element sensor are applied to the control apparatus, wherein the control apparatus is configured to actuate the sorting drive to move the sorting element between the sorting position and the rest position depending on the position values detected by the sorting element sensor. The aforementioned embodiments make it possible to precisely and individually assign a sorting process to an individual pellet based on cavities or else punches. The, for example incremental, position sensor detects the rotary position of the die plate and thus (indirectly) the rotary position of each cavity or else each pair of punches of the die plate. The detected position values are transmitted to the control unit of the rotary press, which uses them to precisely control the sorting drive to sort out a specific pellet assigned to a specific cavity. Furthermore, by using a sorting element sensor to detect the sorting position and/or the rest position of the sorting element, for example a sorting lever, and also feeding these position values to the control apparatus, the rotational position of the rotor of the rotary press can be determined precisely in relation to the position of the sorting element. This ensures that the sorting element moves precisely into the space between two adjacent pellets on the conveying path to the first pellet discharge, so that the correct pellet is specifically detected by the sorting element and deflected out of the conveyor path. The position monitoring of the rest position also ensures that the lever has reached its rest position again in good time before another pellet is sorted out in a manner that would be undesirable. In this way, it is possible to individually sort out pellets even at high rotational speeds. This is not safely possible with pneumatic sorting apparatuses as they are currently used. Among other things, control and valve switching times of the pneumatic sorting apparatuses and the timing of the compressed air pulse can lead to incorrect pellets being sorted out.

The control apparatus can also be configured to actuate the sorting drive to move the sorting element between the sorting position and the rest position depending on a sorting signal from at least one pellet quality sensor of the rotary press. The pellet quality sensor can measure the pellet quality, for example a composition of the pellet. For example, the pellet quality sensor may comprise a spectroscopic sensor, such as an NIR or LIF sensor. It can also be a pressing force sensor that measures the pressing force when pressing the pellets. The pellet quality sensor measures individual and therefore pellet-related quality criteria so that the control apparatus receiving the measurement data can assess whether a particular pellet meets the quality requirements (good) or not (bad). If a pellet is recognized as bad, the sorting apparatus can then be precisely actuated to sort out the pellet recognized as bad in order to sort out exactly the pellet and only the pellet recognized as bad into the second pellet process. As already explained, the control apparatus can also, however, actuate the sorting drive, for example, to sort out a sampling of pellets or to sort out pellets at the beginning and/or at the end of a production process.

The invention also achieves the object by using a rotary press according to the invention for sorting individual pellets into the second pellet discharge. The rotor of the rotary press can be driven at a rotational speed of at least 80 revolutions per minute, in particular at least 100 revolutions per minute, for example up to 120 revolutions per minute.

### BRIEF DESCRIPTION OF THE DRAWINGS

Exemplary embodiments of the invention are explained in greater detail below based on figures. Schematically:

FIG. 1 illustrates an embodiment of a rotary press with a flattened representation of the rotor according to aspects of the present disclosure;

FIG. 2 illustrates an enlarged perspective view of a part of the rotary press of FIG. 1 with an embodiment of a sorting apparatus according to aspects of the present disclosure;

FIG. 3 illustrates shows a perspective view of the embodiment of the sorting apparatus of FIG. 2, according to aspects of the present disclosure;

FIG. 4 illustrates a side view of the embodiment of the sorting apparatus from FIG. 3, according to aspects of the present disclosure;

FIG. 5 illustrates a perspective view of another embodiment of a sorting apparatus, according to aspects of the present disclosure;

FIG. 6a shows a perspective view of a further embodiment of a sorting apparatus according to aspects of the present disclosure;

FIG. 6b shows a perspective view of a further embodiment of a sorting apparatus according to aspects of the present disclosure; and

FIG. 6c. shows a perspective view of a further embodiment of a sorting apparatus according to aspects of the present disclosure.

The same reference numbers refer to the same objects in the figures unless indicated otherwise.

### DETAILED DESCRIPTION

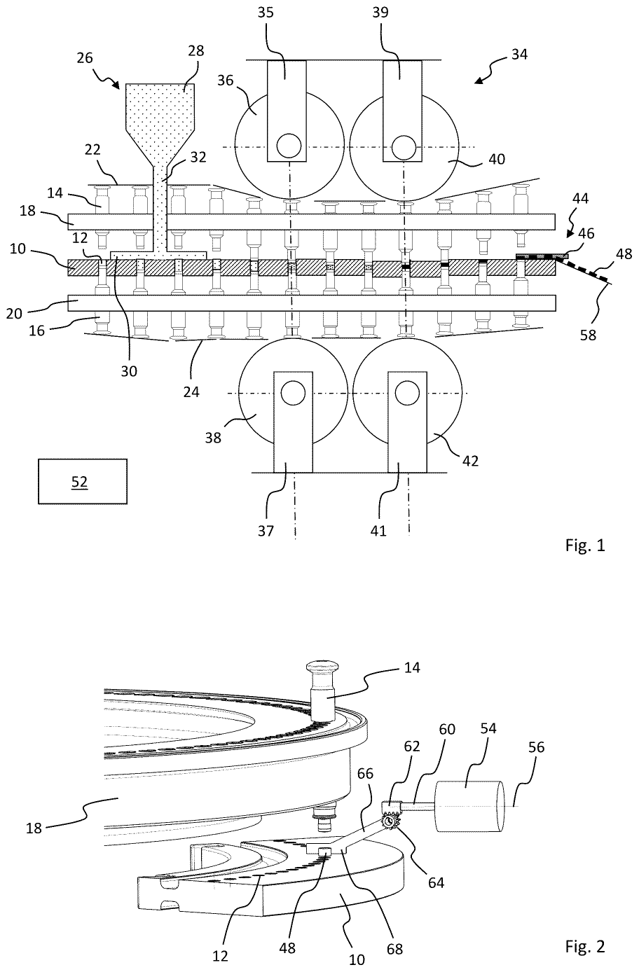

An embodiment of a rotary press according to the invention is shown in FIG. 1. In some embodiments, the rotary press is configured for tablet production in which powdered material is pressed into tablets. The rotor of the rotary press is driven in rotation by a rotary drive and comprises a die plate 10, which has a plurality of cavities 12. The cavities 12 can for example be formed by holes in the die plate 10. Furthermore, the rotor comprises a plurality of upper press punches 14 and lower press punches 16 that rotate synchronously with the die plate 10. The upper press punches 14 are axially guided in an upper punch guide 18 and the lower press punches 16 are axially guided in a lower punch guide 20. The axial movement of the upper press punches 14 and lower press punches 16 during the rotation of the rotor is controlled by upper control cam elements 22 and lower control cam elements 24. Further comprised is a filling apparatus 26, which has a filling reservoir 28 and a filling chamber 30, which are connected via a filling pipe 32. In this way, the powder material in the present example passes under the force of gravity from the filling reservoir 28 via the filling pipe 32 into the filling chamber 30, and passes therefrom via a filling opening provided in the bottom side of the filling chamber 30 into the cavities 12 of the die plate 10, again under the force of gravity.

The rotary press further comprises a pressing apparatus 34. The pressing apparatus 34 comprises a pre-pressing apparatus with an upper pre-pressing roller 36 held on an upper holder 35 and a lower pre-pressing roller 38 held on a lower holder 37, as well as a main pressing apparatus with an upper pressing roller 40 held on an upper holder 39 and a lower pressing roller 42 held on a lower holder 41. In addition, the rotary press comprises a scraping apparatus 44 with a scraping channel 46. The scraping channel scrapes tablets 48 conveyed onto the upper side of the die plate 10 by the lower press punches 16 from the die plate 10 and conveys the tablets 48 through the scraping channel 46 to a first pellet discharge 58. The scraping channel 46 can be sickle-shaped, for example, and is explained in more detail with reference to the following figures. Furthermore, the rotary press comprises a control apparatus 52 for controlling the operation of the rotary press. The rotary press also comprises a second pellet discharge, not shown in detail in FIG. 1, which is located upstream of the first pellet discharge 58 in the direction of rotation of the die plate 10 and can be arranged, for example, parallel to it.

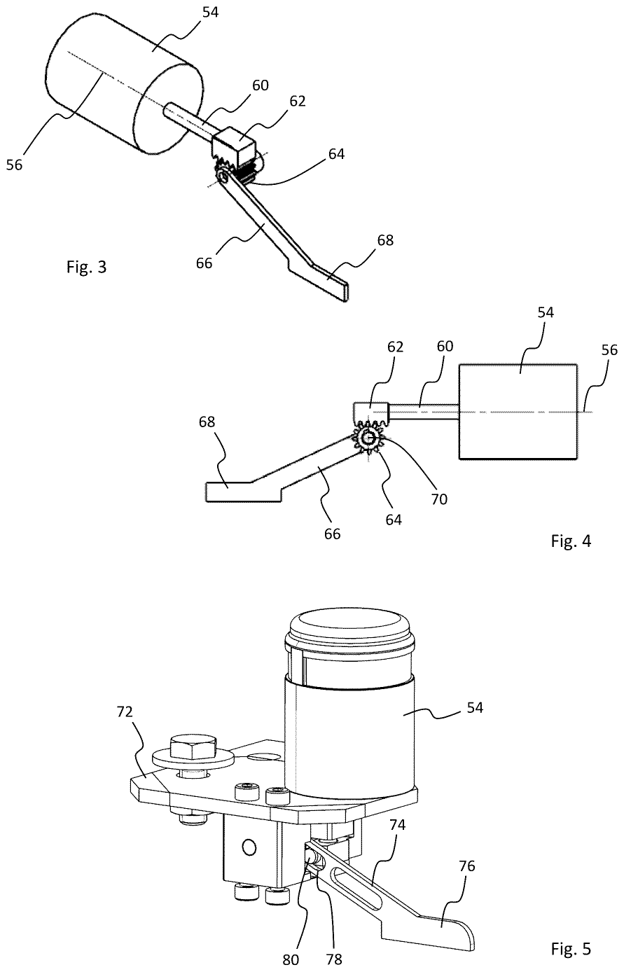

FIGS. 2 to 4 explain a first exemplary embodiment of a sorting apparatus according to the invention. In FIG. 2, only a part of the die plate 10 and the upper punch guide 18 with only one upper press punch 14 is shown for illustration purposes. FIG. 2 shows the cavities 12 which are formed along a circular path in the die plate 10 and in which the upper and lower punches 14, 16 each press the tablets 48. After pressing, the tablets 48 are ejected by the lower press punches 16 onto the upper side of the die plate 10 as explained. FIG. 2 shows an example of this for a tablet 48. The sorting apparatus shown in FIGS. 2 to 4 comprises a sorting drive 54, which comprises, for example, an electric motor 54 designed as a linear drive. A magnet, designed for example an electromagnet, of the electric motor 54 is moved back and forth in a translatory manner along the axis of movement 56. In the exemplary embodiment shown in FIGS. 2 to 4, the magnet, which is movable in a translatory manner, is connected to a transmission pin 60, the longitudinal axis of which corresponds to the axis of movement 56 of the magnet. At its end facing away from the electric motor 54, the transmission pin 60 has a toothed rack portion 62 which engages with a gearwheel 64 of a sorting element. The sorting element comprises a sorting lever 66, at the free end of which a scraping portion 68 is arranged, which in the sorting position shown in FIG. 2 is arranged on the upper side of the die plate 10 in the conveying path of the tablets 48 to the first pellet discharge 58, so that in the example shown in FIG. 2 the tablet 48 shown on the upper side of the die plate 10 is scraped by the scraping portion 68 into the second pellet discharge.

The gearwheel 64 is fixedly arranged at the end of the sorting lever 66, the end lying opposite the scraping portion 68, so that during a translatory movement of the transmission pin 60, driven by the electric motor 54, the sorting lever 66 is rotated about the axis of rotation 70 of the gearwheel 64. In this way, the translatory movement of the transmission pin 60 is translated into a rotatory movement of the sorting lever 66, with a lever ratio of preferably more than 2:1, for example 2.5:1. From the sorting position shown in FIG. 2, the sorting lever 66 can accordingly be pivoted upwards into a rest position by a translatory movement of the transmission pin 60 in the direction of the electric motor 54, in which rest position tablets 48 can pass under the scraping portion 68 further in the direction of the first pellet discharge 58.

FIG. 5 shows a further exemplary embodiment of a sorting apparatus according to the invention. While in the exemplary embodiment shown in FIGS. 2 to 4 the axis of movement of the magnet of the electric motor 54 and thus of the transmission pin 60 runs perpendicular to the axis of rotation of the die plate 10, in the exemplary embodiment of FIG. 5 the axis of movement of the magnet runs parallel to the axis of rotation of the die plate 10, namely along the cylinder axis of the cylindrical housing of the electric motor 54. The electric motor 54 is arranged on a housing plate 72, which can be fastened in the press housing of the rotary press adjacent to the rotating die plate 10. In FIG. 5, the sorting element is also designed as a sorting lever 74, at the free end of which a scraping portion 76 is in turn arranged, which in the sorting position, like the scraping portion 68 according to FIGS. 2 to 4, is arranged on the upper side of the die plate 10 in the conveying path of the tablets 48 to the first pellet discharge 58 and in a rest position is pivoted upwards away from the die plate 10. The scraping function of the scraping portion 76 corresponds to the scraping function of the scraping portion 68.

In the exemplary embodiment according to FIG. 5, the movable magnet of the electric motor 54, which is also designed as a linear drive, drives a transmission projection 80 arranged in an elongated hole 78 of the sorting lever 74 in a translatory manner along the direction of movement of the magnet of the electric motor 54, i.e. in a vertical direction in FIG. 5. In this way, the sorting lever 74 is pivoted between the sorting position and the rest position by a reciprocating movement of the transmission projection 80.

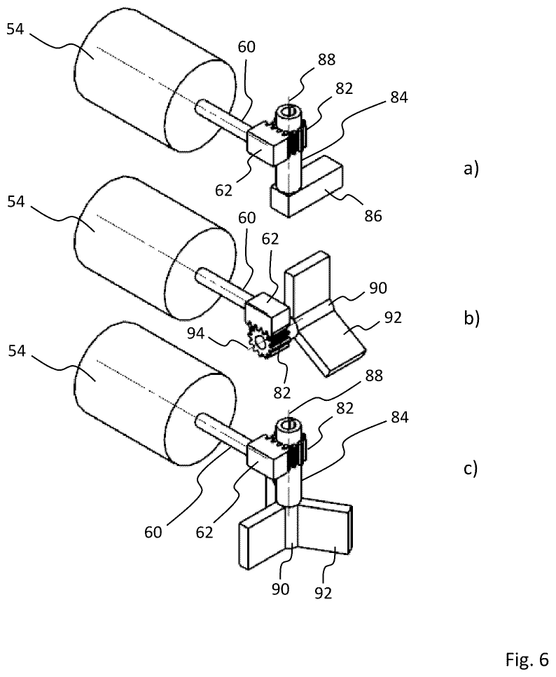

FIG. 6 shows three further exemplary embodiments of a sorting apparatus according to the invention, which initially largely correspond to the exemplary embodiment according to FIGS. 2 to 4 with regard to the electric motor 54 and the transmission pin 60 with toothed rack portion 62. They differ from the exemplary embodiment according to FIGS. 2 to 4 on the one hand with regard to the sorting element and partly with regard to the orientation of the transmission pin 60. Thus, in the exemplary embodiments according to FIGS. 6a) and 6c), the transmission pin 60 with the toothed rack portion 62 is rotated by 90° in each case compared to the exemplary embodiment according to FIG. 4. The toothed rack portions 62 according to FIGS. 6a) and 6c) each engage with a gearwheel 82 formed on a cylindrical holding portion 84. In the exemplary embodiment according to FIG. 6a), a sorting block 86 is formed at the lower end of the holding portion 84, the end facing away from the gearwheel 82 and can be pivoted by the electric motor 54 about the axis of rotation 88 of the holding portion 84 into (sorting position) and out of (rest position) the conveying path of the tablets 48 to the first pellet discharge 58. In the sorting position, the sorting block 86 is in turn located substantially directly above the upper side of the die plate 10 and thus directs the tablets 48 into the second pellet discharge.

In the exemplary embodiment according to FIG. 6c), a sorting wheel 90 is located at the lower end of the holding portion 84, the end facing away from the gearwheel 82, and has three sorting blades 92 in the example shown, which project at equal circumferential distances in the radial direction from the center of the sorting wheel 90. Of course, other numbers of sorting blades 92 are also possible, for example two or four sorting blades 92. The electric motor 54 can be used to rotate the sorting wheel 90 about the axis of rotation 88 of the holding portion 84 substantially directly above the die plate 10 so that, depending on the rotational position, it guides tablets 48 into the second pellet discharge or allows them to pass through to the first pellet discharge 58.

The exemplary embodiment according to FIG. 6b) largely corresponds to the exemplary embodiment according to FIG. 6c), with the difference that the axis of rotation 94 of the gearwheel 82 is tilted by 90°. In this case, the sorting blades 92 of the sorting wheel 90 can in turn be rotated into or out of the conveying path of the tablets 48 on the die plate 10 by corresponding rotation, driven by the electric motor 54.

In the exemplary embodiments according to FIG. 6a) to 6c), the transmission is ensured by the transmission pin 60 with toothed rack portion 62 in engagement with the respective gearwheel 82.

Although the exemplary embodiments shown in the figures describe the electric motor 54 as a linear drive with a magnet that is movable in a translatory manner, it would also be possible to design the electric motor 54 as a rotary drive so that the magnet performs a rotational movement. This could either be transmitted directly, for example, to the gearwheels 64, 82 via a transmission gear. Alternatively, it is also possible to convert the rotary movement of the electric motor 54 into a translatory movement, so that the transmission elements according to the exemplary embodiments can be used again. Furthermore, the movable magnet of the electric motor 54 can be both an electromagnet and a permanent magnet.

### LIST OF REFERENCE SIGNS

10 Die plate
12 Cavities
14 Upper press punches
16 Lower press punches
18 Upper punch guide
20 Lower punch guide
22 Upper control cam elements
24 Lower control cam elements
26 Filling apparatus
28 Filling reservoir
30 Filling chamber
32 Filling pipe
34 Pressing apparatus
35 Upper holder
37 Lower holders
36 Upper pre-pressing roller
38 Lower pre-pressing roller
39 Upper holder
40 Upper pressing roller
41 Lower holder
42 Lower pressing roller
44 Scraping apparatus
46 Scraping channel
48 Pellets/tablets
52 Control apparatus
54 Sorting drive/electric motor
56 Axis of movement
58 Pellet discharge
60 Transmission pin
62 Toothed rack portion
64 Gearwheel
66 Sorting lever
68 Scraping section
70 Axis of rotation
72 Housing plate
74 Sorting lever
76 Scraping section
78 Elongated hole
80 Transmission projection
82 Gearwheel
84 Holding portion
86 Sorting block
88 Axis of rotation
90 Sorting wheel
92 Sorting blade

1. A rotary press comprising:
an upper punch guide for upper press punches and a lower punch guide for lower press punches;
a die plate positioned between the upper and lower punch guides and defining a plurality of cavities, wherein the upper and lower press punches are configured to interact with the plurality of cavities;
a filling apparatus configured to dispense powder material into the plurality of cavities of the die plate;
a pressing apparatus comprising an upper pressing unit and a lower pressing unit, wherein, during operation, the upper pressing unit and the lower pressing unit are configured to interact with the upper press punches and lower press punches, respectively, to press the powder material in the plurality of cavities of the die plate into pellets;
a scraping apparatus configured to scrape pellets ejected onto an upper side of the die plate into a first pellet discharge; and
a sorting apparatus configured to individually sort pellets into a second pellet discharge, wherein the sorting apparatus comprises,
a sorting drive comprising an electric motor with a magnet driven by a stator of the electric motor and a transmission element, and
a sorting element configured to be driven by the sorting drive between a sorting position and a rest position,
wherein, in the sorting position, the sorting element is located in a conveying path of the pellets to the first pellet discharge and is configured to guide pellets from the conveying path into the second pellet discharge,
wherein the magnet translates a drive movement, via the transmission element, into a drive movement of the sorting element with a higher drive speed.

2. The rotary press according to claim 1, wherein the sorting element comprises a sorting lever configured to pivot about a pivot axis between the sorting position and the rest position.

3. The rotary press according to claim 2, wherein the pivot axis of the sorting lever runs parallel to an axis of rotation of the die plate.

4. The rotary press according to claim 2, wherein the pivot axis of the sorting lever runs perpendicular to an axis of rotation of the die plate.

5. The rotary press according to claim 1, wherein the sorting element comprises a sorting wheel configured to be rotated between the sorting position and the rest position and comprises at least one sorting blade.

6. The rotary press according to claim 5, wherein an axis of rotation of the sorting wheel runs parallel to an axis of rotation of the die plate.

7. The rotary press according to claim 5, wherein an axis of rotation of the sorting wheel runs perpendicular to an axis of rotation of the die plate.

8. The rotary press according to claim 2, wherein the magnet is configured to facilitate a translatory movement of the transmission element, wherein the translatory movement of the transmission element is configured to move the sorting element between the sorting position and the rest position.

9. The rotary press according to claim 8, wherein the transmission element comprises a transmission pin including a toothed rack portion, and wherein the toothed rack portion engages with a gearwheel connected to the sorting element in order to transmit the translatory movement of the transmission pin into a pivoting movement or a rotational movement of the sorting element.

10. The rotary press according to claim 9, wherein the sorting lever defines an elongated hole extending along a longitudinal axis, wherein the transmission element comprises a transmission projection configured to engage the elongated hole, wherein the magnet drives the transmission projection in a translatory manner to pivot the sorting lever between the sorting position and the rest position in a direction running at an angle with respect to the longitudinal axis of the elongated hole.

11. The rotary press according to claim 1, wherein the magnet is positioned at a same distance from the stator during the movement of the magnet.

12. The rotary press according to claim 11, wherein the magnet is mounted so as to be rotationally movable relative to the stator by a plain bearing and a spring element

13. The rotary press according to claim 11, wherein the magnet is mounted so as to be moved in a translatory manner relative to the stator by a plain bearing and a spring element.

14. The rotary press according to claim 1, wherein the rotary press further comprises:
a control apparatus; and
a position sensor configured to detect rotational positions of each of the plurality of cavities of the die plate,
wherein values of the rotational positions detected by the position sensor are applied to the control apparatus,
wherein the control apparatus is configured to actuate the sorting drive to move the sorting element between the sorting position and the rest position depending on the values of the rotational positions detected by the position sensor.

15. The rotary press according to claim 14, wherein the sorting apparatus comprises a sorting element sensor configured to detect at least one of: (i) the sorting position of the sorting element; or (ii) the rest position of the sorting element, wherein the values of the rotational positions detected by the sorting element sensor are applied to the control apparatus, and wherein the control apparatus is configured to actuate the sorting drive to move the sorting element between the sorting position and the rest position depending on the values of the rotational positions.

16. The rotary press according to one of claim 15, further comprising at least one pellet quality sensor, wherein the control apparatus is further configured to actuate the sorting drive to move the sorting element between the sorting position and the rest position depending on a sorting signal from the at least one pellet quality sensor of the rotary press.

17. A method of sorting individual pellets into the second pellet discharge using the rotary press according to claim 1.

18. The method according to claim 17, further comprising diving the rotary press at a rotational speed of between at least 80 revolutions per minute to 120 revolutions per minute.
